(19) United States
(12) Patent Application Publication
(10) Pub. No.: US 2006/0222427 A1
(43) Pub. Date: Oct. 5, 2006

(54) Paper feeding cassette for preventing double-feed of paper and image forming apparatus with the same

(75) Inventors: Sung-wook Kang, Seoul (KR); Youn-gun Jung, Gunpo-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/356,084

(22) Filed: Feb. 17, 2006

(30) Foreign Application Priority Data
Apr. 4, 2005 (KR) 10-2005-0028071

(51) Int. Cl. G03G 15/00

(52) U.S. Cl. 399/393

(57) ABSTRACT

A paper feeding cassette and an image forming apparatus with the same are provided. The paper feeding cassette includes a stacking portion for stacking sheets of paper thereon, an inclined wall upwardly slanted relative to the stacking portion, a double-feed preventing unit provided on the inclined wall for separating and conveying the sheet conveyed along the inclined wall, and a coil spring installed in the double-feed preventing unit and applying frictional resistance to one side of the sheet to be conveyed. The paper feeding cassette can effectively prevent double-feed of sheets of paper by changing the shape or arrangement of the coil spring. The coil spring is not worn by the repeated printing. In addition, the paper feeding cassette can be easily manufactured by using the coil spring, and manufacturing costs can be reduced.

### CROSS-REFERENCE TO RELATED PATENT APPLICATION

This application claims the benefit under 35 U.S.C. §119(a) of Korean Patent Application No. 10-2005-0028071, filed on Apr. 4, 2005, in the Korean Intellectual Property Office, the entire disclosure of which is hereby incorporated by reference.

### BACKGROUND OF THE INVENTION

1. Field of the Invention

The present invention relates to an image forming apparatus. More particularly, the present invention relates to a paper feeding cassette capable of preventing double-feed of paper conveyed by a pickup roller, and an image forming apparatus with the same.

2. Description of the Related Art

In general, an image forming apparatus forms a visible image on a recording sheet by fixing a color toner or ink using various image forming methods such as electrophotographic or ink-jet. Such an image forming apparatus includes a paper feeding cassette for stacking sheets of paper thereon.

FIG. 1 is a perspective view illustrating a portion of a conventional paper feeding cassette mounted on an image forming apparatus. Referring to FIG. 1, a paper feeding cassette 1 has a stacking portion 10 for stacking sheets of paper thereon, and an inclined wall 20 upwardly slanted relative to the stacking portion 10. In addition, a pickup roller 15 is installed above the paper feeding cassette 1. The pickup roller 15 is rotated while it presses against an upper surface of the paper, so that paper is conveyed out of the paper feeding cassette 1.

The paper feeding cassette 1 is provided with a double-feed preventing portion 30 on the inclined wall 20 formed at a front end of the paper feeding cassette 1. The double-feed preventing portion 30 separates and conveys the paper conveyed along the inclined wall 20 so that sheets of paper are fed one by one. A rubber 50 is attached to the double-feed preventing portion 30 to easily separate the paper. As the paper feeding cassette is used, however, the rubber 50 is worn due to friction between the rubber 50 and the paper. Consequently, the rubber 50 does not properly prevent double-feed of paper.

An example of a sheet supply device is disclosed in Japanese Patent Laid-Open Publication No. 2003-48637. The sheet supply device includes an inclined plate for preventing double-feed of paper. Fine bosses are formed on the inclined plate in a discrete manner through an etching process. It is difficult and complicated to manufacture an image forming apparatus with such a sheet supply device, thereby causing the cost of the image forming apparatus to increase.

Accordingly, there is a need for an improved paper feeding cassette for preventing double-feed of paper which is simple and easy to manufacture.

### SUMMARY OF THE INVENTION

An aspect of the present invention is to address at least the above problems and/or disadvantages and to provide at least the advantages described below. Accordingly, an aspect of the present invention is to provide a paper feeding cassette capable of effectively preventing double-feed of paper withdrawn from the paper feeding cassette, and an image forming apparatus with the same.

According to an aspect of the present invention, a paper feeding cassette for an image forming apparatus is provided. The paper feeding cassette comprises a stacking portion for stacking sheets of paper thereon, an inclined wall upwardly slanted relative to the stacking portion, a double-feed preventing unit provided on the inclined wall for separating and conveying the sheets conveyed along the inclined wall one by one, and a coil spring installed in the double-feed preventing unit for applying frictional resistance to one side of a sheet to be conveyed.

The coil spring may be installed substantially parallel to a conveying direction of the sheet.

The double-feed preventing unit may comprise a dam portion protruding from the inclined wall. An insertion groove may be formed on the dam portion, into which the coil spring is fit.

The insertion groove may include at least one protrusion which is inserted into one end of the coil spring.

An engaging ring may be formed on at least one end of the coil spring, and the insertion groove may have a complementary engaging portion coupled to the engaging ring.

The insertion groove may have a fixing engaging portion for fixing a distal end of the coil spring.

A tension space may be formed between the coil spring and the insertion groove, so that the coil spring is bent towards the tension space when a front end of the sheet interferes with the coil spring.

The coil spring may be a conical spring having a wider upper portion and a narrower lower portion.

The cross-sectional shape of the coil spring may be rectangular or a truncated conical shape.

The coil spring may be a conical spring having a narrower upper portion and a wider lower portion.

At least two coil springs may be installed substantially parallel to the dam portion.

At least two coil springs may be installed at different positions in the dam portion.

According to another aspect of the present invention, an image forming apparatus including a paper feeding cassette is provided. The paper feeding cassette comprises a stacking portion for stacking sheets of paper thereon, an inclined wall upwardly slanted relative to the stacking portion, a double-feed preventing unit provided on the inclined wall for separating and conveying the sheets conveyed along the inclined wall one by one, and a coil spring installed in the double-feed preventing unit for applying frictional resistance to one side of the sheet to be conveyed.

The coil spring may be installed substantially parallel to a conveying direction of the sheet.

The double-feed preventing unit may comprise a dam portion protruding from the inclined wall. An insertion groove may be formed on the dam portion, into which the coil spring is fit.

The insertion groove may include at least one protrusion which is inserted into one end of the coil spring.

A tension space may be formed between the coil spring and the groove, so that the coil spring is bent towards the tension space when a front end of the sheet interferes with the coil spring.

At least two coil springs may be installed at the dam portion.

### BRIEF DESCRIPTION OF THE DRAWINGS

The above and other objects, features, and advantages of certain exemplary embodiments of the present invention will be more apparent from the following description taken in conjunction with the accompanying drawings, in which:

FIG. 1 is a perspective view of a portion of a conventional paper feeding cassette for an image forming apparatus;

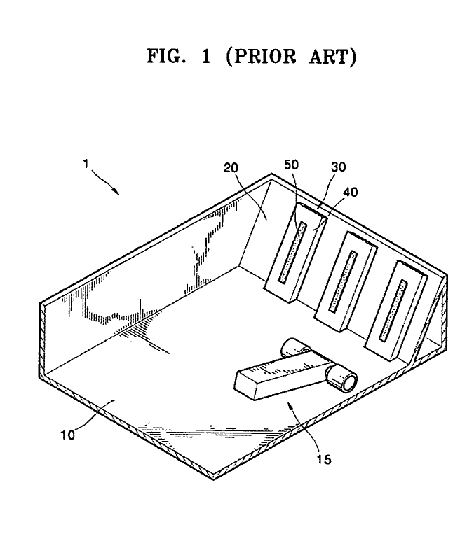

FIG. 2 is a schematic cross-sectional view of an image forming apparatus according to an exemplary embodiment of the present invention;

FIG. 3 is a perspective view of a portion of a paper feeding cassette according to an exemplary embodiment of the prevent invention;

FIG. 4A is a perspective view of a double-feed preventing unit of the paper feeding cassette shown in FIG. 3 according to an exemplary embodiment of the present invention;

FIG. 4B is a perspective view of a double-feed preventing unit according to an exemplary embodiment of the present invention;

FIG. 5 is a cross-sectional view of a double-feed preventing unit according to another exemplary embodiment of the present invention;

FIGS. 6 through 9 are cross-sectional views of double-feed preventing units according to other exemplary embodiments of the present invention;

FIGS. 10 and 11 are schematic views of a coil spring installed at a double-feed preventing unit according to an exemplary embodiment of the present invention;

FIGS. 12A and 12B are schematic views of a coil spring installed at a double-feed preventing unit according to another exemplary embodiment of the present invention; and

FIGS. 13 and 14 are schematic views of a plurality of coil springs installed at a double-feed preventing unit according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the exemplary embodiments of the invention. Accordingly, those of ordinary skill in the art will recognize that various changes and modifications of the exemplary embodiments described herein can be made without departing from the scope and spirit of the invention. Also, descriptions of well-known functions and constructions are omitted for clarity and conciseness.

In the following description, an image forming apparatus will be first described. Then, a paper feeding cassette installed in the image forming apparatus will be described. In the following description, an electrophotographic type image forming apparatus is used as an example of an image forming apparatus. It should be understood, however, that the present invention is not limited to electrophotographic type apparatuses. For example, the present invention may be used with an inkjet printer that includes a line type inkjet head having a nozzle unit with a length that substantially corresponds to a width of a sheet of paper. Also, the present invention may be applied to an inkjet printer that uses a shuttle type inkjet head to print an image on the paper by discharging ink onto the paper, with the head being moved in a direction substantially perpendicular to the direction that the paper is conveyed.

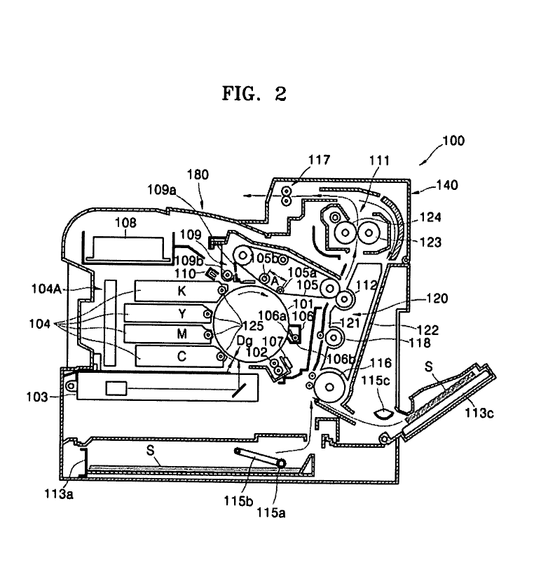

FIG. 2 is a cross-sectional view schematically illustrating an image forming apparatus 100 according to an exemplary embodiment of the present invention. Referring to FIG. 2, the image forming apparatus 100 includes a photosensitive medium 101, a charging roller 102, a light scanning unit 103, four developing devices 104, and a transfer belt 105, which are enclosed by a frame 140.

The photosensitive medium 101 has a cylindrical metal drum having an outer circumference which is coated with a layer of a photoconductive material through deposition, for example. The photosensitive medium 101 is rotated in a predetermined direction, and an electrostatic latent image corresponding to an image to be printed is formed onto the outer circumference with light emitted from the light scanning unit 103.

The charging roller 102 is one example of a charger for charging the outer circumference of the photosensitive medium 101 to a uniform potential. The charging roller 102 supplies the potential to the outer circumference of the photosensitive medium 101 while it rotates in contact with or without contacting the outer circumference of the photosensitive medium 101, thereby providing the outer circumference of the photosensitive medium 101 with the uniform potential. A charging bias voltage is applied to the charging roller 102 to charge the outer circumference of the photosensitive medium 101 to the uniform potential. The charging roller 102 may be replaced by a corona charger (not shown).

The light scanning unit 103 is disposed under the photosensitive medium 101 to emit light corresponding to image information onto the outer circumference of the photosensitive medium 101 charged to the uniform potential according to a computer signal, thereby forming an electrostatic latent image on the outer circumference of the photosensitive medium 101. The light scanning unit 103 includes a light source (not shown) for scanning a laser beam, and a beam deflector for deflecting the laser beam emitted from the light source. A laser scanning unit (LSU) is generally used as the light scanning unit 103.

The four developing devices 104C, 104M, 104Y and 104K are detachably mounted in the frame 140 in a cartridge manner, and contain solid powdery toners of cyan C, magenta M, yellow Y, and black K therein, respectively. The four developing devices 104C, 104M, 104Y and 104K are replaced by new ones when the toner stored in each developing device is completely consumed.

The developing roller 125 adheres the toner contained in the developing devices to the outer circumference of the developing roller 125, so as to supply the toner to the photosensitive medium 101. The developing roller 125 contains toner particles on its outer circumference, and supplies the toner to the electrostatic latent image formed on the photosensitive medium 101 to develop the toner image. A developing bias voltage is applied to the developing roller 125 to supply the toner to the photosensitive medium 101.

The four developing devices 104C, 104M, 104Y and 104K are disposed so that the developing roller 125 is spaced apart from the outer circumference of the photosensitive medium 101 at a desired developing gap Dg. A force in the direction from the photosensitive medium 101 to the developing roller 125 is induced by an electric field formed between the four developing devices 104C, 104M, 104Y and 104K and the photosensitive medium 101, so that the charged toner moves across the developing gap Dg to perform the development operation.

A developing device driving device 104A is installed at one side of the four developing devices 104C, 104M, 104Y and 104K to selectively drive the developing devices.

In this exemplary embodiment, the cyan developing device 104C, the magenta developing device 104M, the yellow developing device 104Y, and the black developing device 104K are sequentially disposed from bottom to top. A pre-transfer eraser 110 is disposed on the uppermost developing device 104K. The light scanning unit 103 and an eraser lamp 107 are disposed below the photosensitive drum 101. A paper conveying unit 120 is rotatably installed opposite to the developing devices 104C, 104M, 104Y and 104K, with the photosensitive medium being interposed between the paper conveying unit 120 and the developing devices 104C, 104M, 104Y and 104K.

The toner images of cyan C, magenta M, yellow Y and black K are sequentially formed on the photosensitive medium 101, and are then sequentially transferred onto the transfer belt 105 from the photosensitive medium. The color toner image can be formed by overlapping the toner images onto the transfer belt 105. In general, the length of the transfer belt 105 should be equal to or larger than that of a sheet S with the color toner image finally formed thereon.

A plurality of support rollers which contact an inner circumference of the transfer belt 105 are installed inside the transfer belt 105 to support the transfer belt 105. The transfer belt 105 is rotated in a desired direction. A nip roller 105a is installed on the inner circumference of the transfer belt 105 to maintain a constant nip A between the photosensitive medium 101 and the transfer belt 105. A first transfer bias voltage is applied to an intermediate transfer roller 105b to transfer the toner images to the transfer belt 105 from the photosensitive medium 101.

The transfer belt 105 is placed opposite to the photosensitive medium 101 in a section between the intermediate transfer roller 105b and the nip roller 105a so that the toner image developed on the outer circumference of the photosensitive medium 101 is transferred to the transfer belt 105 from the photosensitive medium 101. Specifically, while the transfer belt 105 is supported by a plurality of rollers and is rotated along a given track, the toner image developed on the outer circumference of the photosensitive medium 101 is transferred onto the transfer belt 105 from the photosensitive medium 101.

A first cleaning unit 106 includes a first blade 106a that contacts the surface of the photosensitive medium 101 and scrapes any waste toner remaining on the surface of the photosensitive medium 101 after the transfer process, and a first transporting unit 106b for transporting the waste toner to a waste toner storage unit (not shown). The first toner transporting means 106b may be an auger.

A second cleaning unit 109 removes any waste toner remaining on the transfer belt 105 after the toner image is transferred to the sheet S. The second cleaning unit 109 includes a second blade 109a for scraping any waste toner remaining on the surface of the transfer belt 105, and a second transporting unit 109b for transporting any waste toner to the waste toner storage unit (not shown). The second toner transporting means 109b may be an auger.

A transfer roller 112 is placed opposite to the surface of the transfer belt 105 onto which the toner image of the transfer belt 105 is to be transferred. A transfer bias voltage having a polarity opposite to that of the toner image is applied to the transfer roller 112 so that the toner image transferred onto the transfer belt 105 is moved to the sheet S transferred between the transfer belt 112 and the transfer belt 105. The toner image is transferred onto the sheet S by the electrostatic force acting between the transfer belt 105 and the transfer roller 112. The transfer roller 112 is spaced apart from the transfer belt 105, while the color tone image is transferred onto the transfer belt 105. When the color toner image is completely transferred to the transfer belt 105, the transfer roller 112 contacts the transfer belt 105 with predetermined pressure to transfer the toner image onto the sheet S. In addition, the toner image transferred onto the outer circumference of the transfer belt 105 may be transferred onto the sheet S passing through the transfer roller 112 and the transfer belt 105 by contact pressure between the transfer belt 105 and the transfer roller 112.

The pre-transfer eraser 110 removes the charge from a portion of the photosensitive medium 101 in which the toner image is formed, except for the charge on the toner image, before the toner image is transferred onto the transfer belt 105 from the photosensitive medium 101. By removing the charge, the pre-transfer eraser 110 improves the efficiency of transferring the toner image from the photosensitive medium 101 onto the transfer belt 105.

The eraser lamp 107 is an example of an eraser for removing the electric charge remaining on the outer circumference of the photosensitive medium 101 which is produced by the charging process. The eraser lamp 107 irradiates a predetermined amount of light onto the outer circumference of the photosensitive medium 101 to remove the electric charge from the outer circumference of the photosensitive medium 101.

A high voltage power supply 108 applies a voltage to components mounted on the image forming apparatus. For example, the power supply 108 supplies a developing bias voltage for developing toner from the developing device 104 to the photosensitive medium 101, an anti-developing bias voltage for preventing toner from being attached to the photosensitive medium 101 from the developing device 104, a first transfer bias voltage for transferring the toner image from the photosensitive medium 101 onto the transfer belt 105, a second transfer bias voltage for transferring the toner image from the transfer belt 105 onto the sheet S, a charging bias voltage to be supplied to the charging roller 102, and the like.

A fixing portion 111 fixes the toner image on the sheet S by applying heat and pressure onto the toner image transferred onto the sheet S, and includes a heat roller 123 and a press roller 124 placed opposite to the heat roller 123. The heat roller 123 is a heat source for permanently fixing the toner image on the sheet S, and is placed axially opposite to the press roller 124. The press roller 124 is placed opposite to the heat roller 123 so that the sheet S passing through the nip between the press roller 124 and the heat roller 123 is pressed to fix the toner image on the sheet S.

A paper discharging roller 117 discharges the sheet S, on which the fixation is completed, out of the image forming apparatus 100. The sheet S discharged from the image forming apparatus is stacked on a paper discharging portion 180.

The image forming apparatus 100 includes a paper feeding cassette 113a placed under the apparatus for stacking sheets of paper thereon. The paper feeding cassette 113a is an example of a unit for stacking sheets S of paper. The unit for stacking the sheets may also include a multi-purpose feeder 113c for storing additional sheets S. The multi-purpose feeder 113c is mainly used to convey OHP sheets or non-standard sheets S.

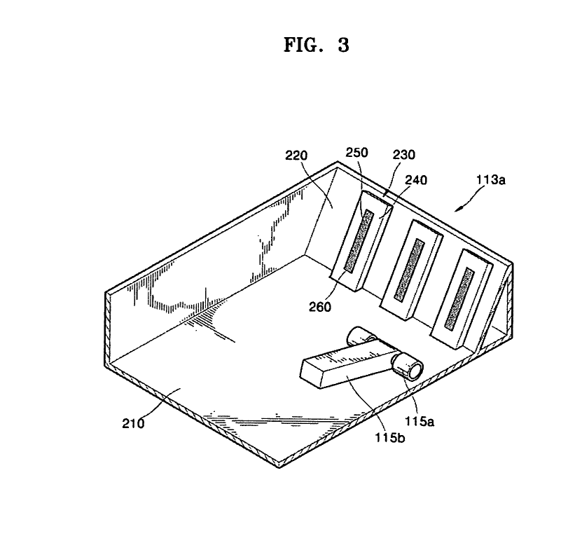

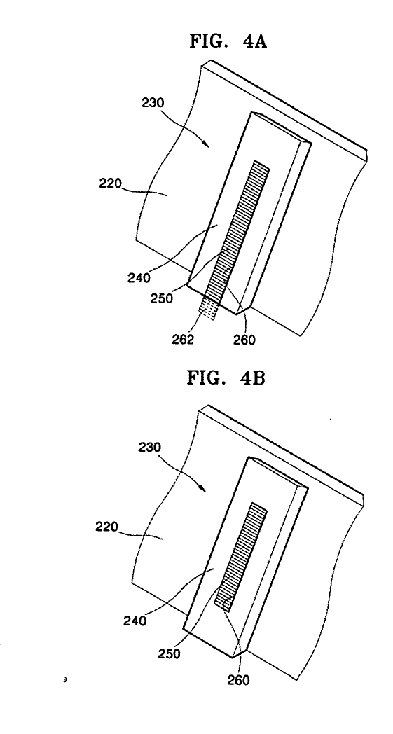

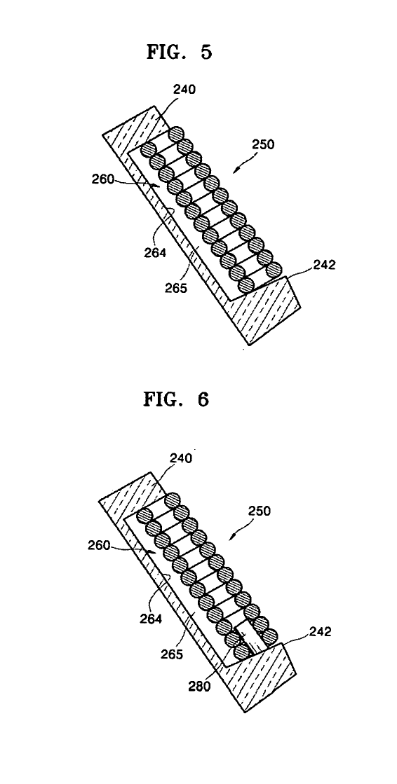

FIG. 3 is a perspective view illustrating a portion of the paper feeding cassette according to an exemplary embodiment of the prevent invention. FIG. 4A is a perspective view illustrating a double-feed preventing unit of the paper feeding cassette shown in FIG. 3 according to an exemplary embodiment of the present invention. FIG. 4B is a perspective view illustrating a double-feed preventing unit according to another exemplary embodiment of the present invention;

Referring to FIGS. 3, 4A and 4B, the paper feeding cassette 113a has a stacking portion 210 for stacking sheets of paper thereon, and an inclined wall 220 upwardly slanted relative to the stacking portion 210. The stacking portion 210 is a substantially flat plate. The inclined wall 220 may be formed at an angle which is the most suitable for separating the sheets S. Also, the paper feeding cassette 113a is provided with a pickup roller 115a at one side thereof. The pickup roller 115a is installed to an end of a pivotable picking arm 115b, so that the pickup roller 115a rotates, with it pressing against the topmost sheet S with predetermined pressure, according to the remaining amount of sheets S. The pickup roller 115a is rotated while it presses against an upper surface of the paper, so that the paper is conveyed out of the paper feeding cassette 113a.

During the printing operation, double feed in which several sheets S stacked on the stacking portion 210 are picked up at once may occur. Hence, a frictional pad (not shown) may be further included on an upper surface of the stacking portion 210 at a position opposite to the pickup roller 115a. The frictional pad applies a frictional force larger than a frictional force between the sheets S onto a rear surface of the sheet S to prevent double-feed of sheets.

The inclined wall 220 formed at a front end of the paper feeding cassette 113a is provided with a double-feed preventing unit 230. The double-feed preventing unit 230 separates and conveys the paper conveyed along the inclined wall 220 one by one. To perform the separating function, the double-feed preventing unit 230 includes a coil spring 250 for applying frictional resistance to one side of the sheet S to convey the uppermost sheet S only. The frictional resistance between the coil spring 250 and the sheet S is larger than the frictional force between the sheets S. The coil spring 250 may be installed substantially parallel to the conveying direction of the sheet S to prevent double-feed of sheets S. When the front sides of the sheets S contact every joint of the coil spring 250, the sheets S are provided with a frictional resistance. Thus, only the top sheet is fed, and double-feed of the sheet S is effectively prevented.

The double-feed preventing unit 230 may be directly installed at the inclined wall 220, or may be installed at a dam portion 240 that protrudes from the inclined wall 220, as shown in FIGS. 4A and 4B. Also, the coil spring 250 may be installed into an insertion groove formed on the inclined wall 220, or may be inserted into an insertion groove 260 formed on the dam portion 240, as shown in FIGS. 4A and 4B.

The coil spring 250 may be installed so that the front end of the conveying sheet S is not caught by a lower end of the coil spring 250. For example, one end 262 of the insertion groove 250 may be lower than the stacking portion 210, as shown in FIG. 4A, so that when the coil spring 250 is inserted into the insertion groove 260, the end 262 of the insertion groove 250 does not catch the front end of a sheet S. Alternatively, when the insertion groove 260 is formed at a middle portion of the double-feed preventing unit 230, as shown in FIG. 4B, the double-feed preventing unit 230 receiving the lower end of the coil spring 250 may be deeper than the end of the coil spring 250. That is, the depth of the insertion groove 260 that receives the coil spring 250 may be larger than the diameter of the coil spring 250.

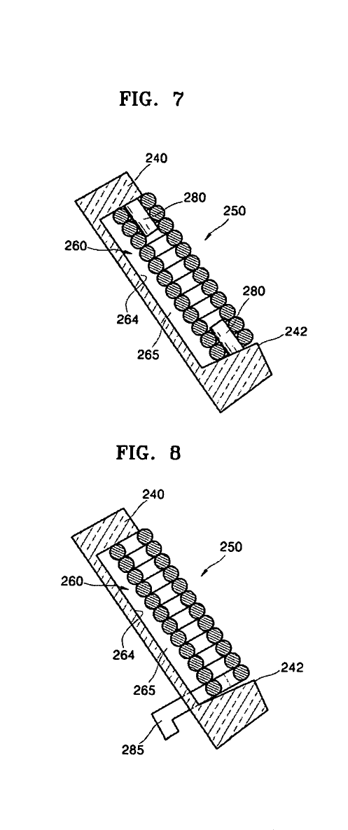

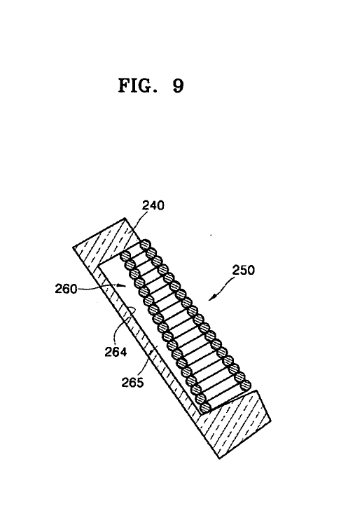

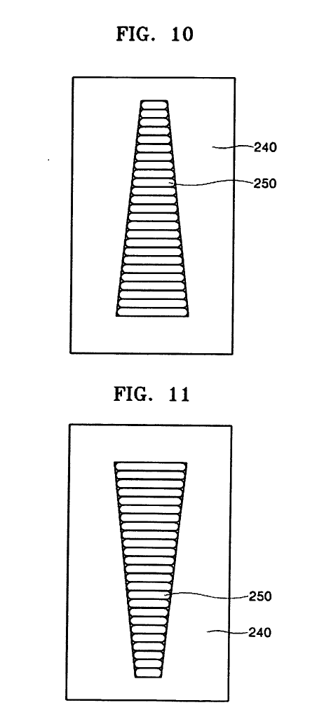

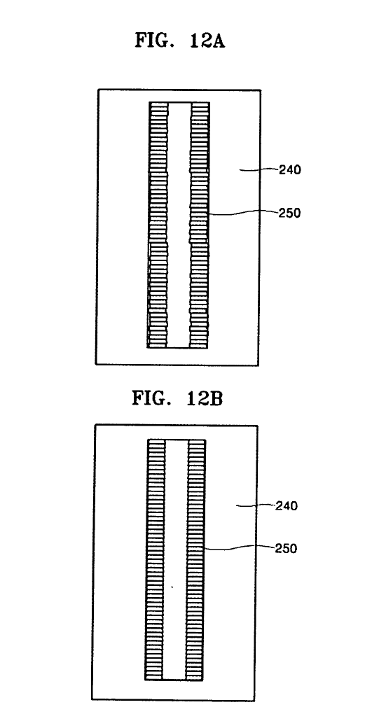

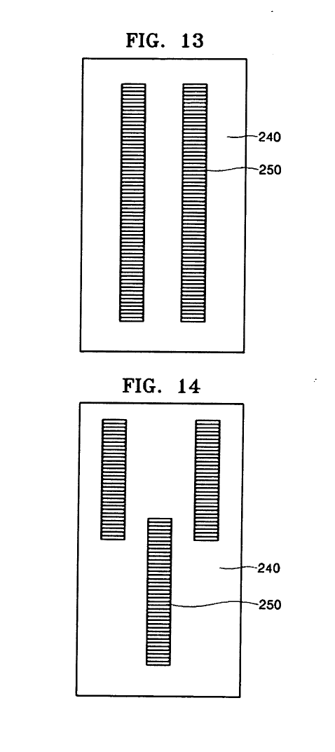

FIG. 5 is a cross-sectional view of the double-feed preventing unit according to another exemplary embodiment of the present invention. FIGS. 6 through 9 are cross-sectional views of the double-feed preventing unit according to other exemplary embodiments of the present invention. FIGS. 10 and 11 are schematic views of a coil spring installed at a double-feed prevention member according to an exemplary embodiment of the present invention. FIGS. 12A and 12B are schematic views of a coil spring installed at a double-feed prevention member according to another exemplary embodiment of the present invention. FIGS. 13 and 14 are schematic views of a plurality of coil springs installed at the double-feed preventing unit according to exemplary embodiments of the present invention. In FIGS. 5 through 14, like reference numbers refer to like elements shown in FIGS. 3 and 4, and a detailed description is therefore not repeated.

Referring to FIG. 5, a tension space 265 may be formed between the coil spring 250 and the insertion groove 260. The coil spring 250 is bent towards the tension space 265 when the front end of the conveying sheet S interferes with the coil spring 250. Since there is a space in which the coil spring 250 is bent, the double feed of the sheet S can be more effectively prevented. That is, a restoring force is applied to the coil spring 250 bent towards the tension space 265. Since the coil spring 250 presses one side of the sheet S with the restoring force, the double feed of the sheet S can be more effectively prevented. Specifically, the coil spring 250 applies a stronger frictional resistance to one side of the conveying sheet S because of the restoring force, so that double feed of the sheets S can be more effectively prevented.

In one exemplary embodiment, at least one protrusion 280 inserted into one end of the coil spring 250 may be included in the insertion groove 260, as shown in FIGS. 6 and 7. Specifically, one protrusion 280 formed at the insertion groove 260 may be inserted into one end of the coil spring 250 (see FIG. 6), or two protrusions 280 formed at the insertion groove 260 may be inserted into both end of the coil spring 250 (see FIG. 7). FIG. 6 shows the case where the protrusion 280 is formed at a lower portion of the insertion groove 260 is inserted into only one end of the coil spring 250. FIG. 7 shows the case where two protrusions 280 formed at upper and lower portions of the insertion groove 260 are inserted into both ends of the coil spring 250. The tension force of the coil spring 250 may be adjusted by inserting the protrusion 280 into the end of the coil spring 250. Hence, the tension force of the coil spring 250 may be adjusted by the protrusion 280 to accomodate different shapes or uses of the paper feeding cassette (for example, whether it is mainly used in high speed printing or low speed printing, whether it is mainly used for a large image forming apparatus or a small image forming apparatus, and the like). The tension force of the portion of the coil spring 250 which receives the protrusion is weaker than that of the portion of the coil spring 250 which does not receive the protrusion 280. That is, the tension force of the portion of the coil spring 250 which does not receive the protrusion is strong. Although not shown, instead of the structure of the coil spring which receives the protrusion, an engaging ring may be formed at at least one end of the coil spring, and an engaging portion of the coil spring, which is complementarily coupled to the engaging ring, may be formed in the insertion groove.

In another exemplary embodiment, a fixing engaging portion 285 for fixing the distal end of the coil spring 250 may be formed in the insertion groove 260, as shown in FIG. 8. The fixing engaging portion 285 may be a C-shaped ring. One or both ends of the coil spring 250 may be inserted into a C-shaped ring formed at one or both ends of the insertion groove 260. If the ends of the coil spring 250 are fixed as described above, a tension effect can be produced in an area wider than exemplary embodiments shown in FIGS. 6 and 7.

In another exemplary embodiment, the coil spring 250 inserted into the insertion groove 260 may be a conical spring having a narrower upper portion and a wider lower portion, as shown in FIGS. 9 and 10, or may be a conical spring having a wider upper portion and a narrower lower portion, as shown in FIG. 11. In the case of the conical spring, since the tension forces of the wider and narrower portions, that is, the upper and lower portions, are different from each other, the frictional forces applied to the sheets S are significantly different from each other. Specifically, the tension force of the wider portion is weak, but the tension force of the narrower portion is strong. Consequently, it is possible to prevent the double feed of the sheet S by selecting a conical spring which is appropriate for the shape or usage of the paper feeding cassette.

The coil springs 250 shown in FIGS. 5 through 11 are described with reference to the cases where the cross section is a circular shape. As shown in FIGS. 12A and 12B, however, the cross-sectonal shape of the coil spring 250 may be rectangular (see FIG. 12A) or a truncated conical shape (see FIG. 12B). In the case of the rectangular or truncated conical cross section, the angled cross section becomes a frictional surface to apply frictional resistance to the front end of the conveying sheet S. A coil spring 250 with a rectangular or truncated conical cross section may apply a larger frictional resistance to the front end of the conveying sheet S, than a coil spring 250 with circular cross section, thereby effectively preventing the double feed of the sheet S.

In an exemplary embodiment, at least two coil springs 250 may be installed substantially parallel to the dam portion 240, as shown in FIG. 13. Alternatively, the coil springs may be installed in the dam portion 240 at different positions, as shown in FIG. 14. Thus, a plurality of coil springs 250 may be placed in the dam portion 240 to increase the frictional resistance applied to the front end of the sheet S. The frictional resistance applied to the front end of the sheet S may be increased by placing the coil spring 250 at appropriate places.

Referring to FIG. 2, the pickup rollers 115a and 115c are installed on the upper portion of the paper feeding cassettes 113a and 113c to convey a sheet S stacked on the paper feeding cassettes 113a and 113c to the feed roller 116.

The feed roller 116 feeds a sheet S discharged from the paper feeding cassettes 113a and 113c by the pickup rollers 115a and 115c to the paper conveying unit 120.

The paper conveying unit 120 includes a paper feeding path 121 for guiding the sheet S between the feed roller 116 and the fixing portion 111, and a duplex path 122 for printing both surfaces of a sheet S. A registration roller 118 is installed at the paper conveying unit 120. The registration roller 118 registers the sheet S to transfer the toner image onto a desired portion of the sheet S, before the sheet S which is conveyed from the feed roller 116 passes through the nip between the transfer belt 105 and the transfer roller 112. When the sheet S passes through the nip between the transfer belt 105 and the transfer roller 112, the toner image is transferred onto the sheet S. The toner image transferred onto the sheet S is fixed to the sheet S through the fixing portion 111, and is discharged out of the image forming apparatus 100 by the paper discharging roller 117.

During double-sided printing, the paper discharging roller 117 is rotated in reverse, and the sheet S is conveyed along the duplex path 122. Then, the sheet S is turned over so that an image is printed on a surface of the sheet which is not already printed with an image. The turned-over sheet S is again conveyed through the paper feeding path 121 by the feed roller 116, thereby printing the image on the other surface.

The operation of the paper feeding cassette according to the exemplary embodiments of the present invention and the image forming apparatus with the same will now be described in detail.

Color image information corresponding to cyan C, magenta M, yellow Y, and black K colors is provided to the image forming apparatus. In this exemplary embodiment, the toner image is overlapped onto the transfer belt 105 in the order of cyan C, magenta M, yellow Y, and then black K, and the toner image is transferred onto the sheet S and fixed thereto, thereby forming the color image.

The outer circumference of the photosensitive medium 101 is charged with a uniform potential by the charge roller 102. When an optical signal corresponding to the cyan C image information is irradiated onto the rotating photosensitive medium 101 by the light scanning unit 103, resistance is decreased in the portion irradiated by the light, and electric charges attached to the outer circumference of the photosensitive medium 101 are detached from the outer circumference of the photosensitive medium 101. Hence, there is potential difference between the portion with the light irradiated and the portion that is not irradiated, so that an electrostatic latent image is formed on the outer circumference of the photosensitive medium 101.

While the photosensitive medium 101 is rotating, the electrostatic latent image approaches the cyan developing device 104C. At this time, the developing roller 125 of the cyan developing device 104C starts rotating. Then, a developing bias voltage is applied to the developing roller 125 of the cyan developing device 104C from the high voltage power supply 108. Meanwhile, an anti-developing bias voltage is applied to the developing roller 125 of the other developing devices 104M, 104Y and 104K to prevent development operations by these devices. Hence, only cyan C toner crosses the developing gap Dg and is attached to the electrostatic latent image formed on the photosensitive medium 101, thereby forming a cyan C toner image.

If the cyan C toner image approaches the transfer belt 105 by rotation of the photosensitive medium 101, the toner image is transferred onto the transfer belt 105 with a first transfer voltage or the contact pressure between the photosensitive medium 101 and the transfer belt 105.

If the cyan C toner image is completely transferred onto the transfer belt 105, the magenta M, yellow Y, and black K toner images are transferred onto the transfer belt 105 using the same process. At this time, the device 104A drives the developing device driving devices 104C, 104M, 104Y and 104K to develop the toner image through the above-described procedures.

During this process, the transfer roller 112 is spaced apart from the transfer belt 105. Once all four colors of toner images are transferred onto the transfer belt 105 and the color toner image is formed on the transfer belt 105, the transfer roller 112 contacts the transfer belt 105 to transfer the color toner image to the sheet S.

A sheet S is fed from the paper feeding cassette 113a or the MPF 113c so that the front end of the sheet S reaches the position at which the transfer belt 105 contacts the transfer roller 105 at substantially the same time as when a front end of the color toner image formed on the transfer belt 105 reaches the position. At this time, when a plurality of sheets S are conveyed by the pickup roller 115a, the front end of the sheet S interferes with the coil spring 250, and only the uppermost sheet S is conveyed to the feed roller 116. That is, only the uppermost sheet S is conveyed to the transfer roller 112 through the feed roller 116 by the frictional resistance produced by the coil spring 250. When the sheet S passes through the nip between the transfer belt 105 and the transfer roller 112, the color toner image is transferred to the sheet S by the second transfer bias voltage. Then, the color toner image is fixed to the sheet S by heat and pressure in the fixing portion 111 to complete the formation of the color image.

For the next printing operation, the first and second cleaning units 106 and 109 remove any waste toner left on the photosensitive medium 101 and the transfer belt 105, and the eraser lamp 107 irradiates the light onto the photosensitive medium 101 to remove the remaining charge on the photosensitive medium 101.

Thus, the present invention effectively prevents double-feed of sheets S. Further, by changing the shape or arrangement of the coil spring, the present invention effectively prevents double-feed of sheets S. Also, the coil spring of the exemplary embodiments of the present invention is not worn by repeated printing operations. In addition, the described apparatus can be easily manufactured by using a coil spring, and manufacturing costs can be reduced.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A paper feeding cassette comprising:
a stacking portion for stacking sheets of paper thereon;
an inclined wall that is upwardly slanted relative to the stacking portion;
a double-feed preventing unit provided on the inclined wall for separating and conveying a sheet conveyed along the inclined wall; and
a coil spring installed in the double-feed preventing unit and applying frictional resistance to one side of the sheet to be conveyed.

2. The paper feeding cassette according to claim 1, wherein
the coil spring is substantially parallel to a conveying direction of the sheet.

3. The paper feeding cassette according to claim 2, wherein the double-feed preventing unit comprises:
a dam portion protruding from the inclined wall; and
an insertion groove formed on the dam portion for accomodating the coil spring.

4. The paper feeding cassette according to claim 3, wherein
the insertion groove includes at least one protrusion inserted into one end of the coil spring.

5. The paper feeding cassette according to claim 3, wherein
an engaging ring is formed on at least one end of the coil spring, and the insertion groove has a complementary engaging portion coupled to the engaging ring.

6. The paper feeding cassette according to claim 3, wherein
the insertion groove has a fixing engaging portion for fixing a distal end of the coil spring.

7. The paper feeding cassette according to claim 3, wherein
a tension space is formed between the coil spring and the insertion groove, so that the coil spring is bent towards the tension space when a front end of the sheet interferes with the coil spring.

8. The paper feeding cassette according to claim 7, wherein
the coil spring is a conical spring having a wider upper portion and a narrower lower portion.

9. The paper feeding cassette according to claim 8, wherein
the cross-sectional shape of the coil spring is rectangular or a truncated conical shape.

10. The paper feeding cassette according to claim 7, wherein
the coil spring is a conical spring having a narrower upper portion and a wider lower portion.

11. The paper feeding cassette according to claim 10, wherein
the cross-sectional shape of the coil spring is rectangular or a truncated conical shape.

12. The paper feeding cassette according to claim 7, wherein
the cross-sectional shape of the coil spring is rectangular or a truncated conical shape.

13. The paper feeding cassette according to claim 7, wherein
at least two coil springs are installed substantially parallel to the dam portion.

14. The paper feeding cassette according to claim 7, wherein
at least two coil springs are installed in the dam portion at different positions.

15. An image forming apparatus comprising a paper feeding cassette, wherein the paper feeding cassette comprises:
a stacking portion for stacking sheets of paper thereon;
an inclined wall upwardly slanted relative to the stacking portion;
a double-feed preventing unit provided on the inclined wall for separating and conveying the sheet conveyed along the inclined wall; and
a coil spring installed in the double-feed preventing unit and applying frictional resistance to one side of the sheet to be conveyed.

16. The image forming apparatus according to claim 15, wherein
the coil spring is installed substantially parallel to a conveying direction of the sheet.

17. The image forming apparatus according to claim 16, wherein the double-feed preventing unit comprises:
a dam portion protruding from the inclined wall; and
an insertion groove formed on the dam portion for accomodating the coil spring.

18. The image forming apparatus according to claim 17, wherein
he insertion groove includes at least one protrusion inserted into one end of the coil spring.

19. The image forming apparatus according to claim 17, wherein
a tension space is formed between the coil spring and the insertion groove, so that the coil spring is bent towards the tension space when a front end of the sheet interferes with the coil spring.

20. The image forming apparatus according to claim 17, wherein
at least two coil springs are installed in the dam portion.
